(19) United States
(12) Patent Application Publication
(10) Pub. No.: US 2015/0262143 A1
(43) Pub. Date: Sep. 17, 2015

(54) SOCIAL NETWORKING SYSTEM AND METHOD

(71) Applicant: RedFinger, Inc., South Riding, VA (US)

(72) Inventors: Raymond Roberts, Chantilly, VA (US); John Jung, Orangeburg, NY (US)

(21) Appl. No.: 14/659,134

(22) Filed: Mar. 16, 2015

Related U.S. Application Data
(60) Provisional application No. 61/953,218, filed on Mar. 14, 2014.

(51) Int. Cl. G06Q 20/08

(52) U.S. Cl. CPC G06Q 20/08; G06Q 50/01

(57) ABSTRACT

A method, computer program product, and computing system for defining a plurality of users within a social network, wherein a social currency amount is associated with each of the plurality of users of the social network. A social network bank is established within the social network, wherein the social network bank is configured to effectuate one or more social currency exchanges between at least one user of the plurality of users of the social network and a commercial banking institution.

### RELATED APPLICATION

This application claims the benefit of U.S. Provisional Application No. 61/953,218, filed on 14 Mar. 2014 and entitled “SOCIAL NETWORKING SYSTEM AND METHOD”, the contents of which is incorporated by reference.

### TECHNICAL FIELD

This disclosure relates to social networking systems and, more particularly, to social network systems that allow for the transfer of social currency between its users.

### BACKGROUND

Social networking is very popular and allows for users of such social networking websites to document various events and aspects of their lives by posting original content to these social networking websites. Unfortunately, the generation of such original content is time consuming and labor intensive. Further, while large quantities of revenue are generated by such social networking websites, that revenue does not trickle down to the individual users (i.e., the providers/generators of the content available on these websites).

### SUMMARY OF DISCLOSURE

In one implementation, a computer-implemented method is executed on a computing device. The computer-implemented method includes defining a plurality of users within a social network, wherein a social currency amount is associated with each of the plurality of users of the social network. A social network bank is established within the social network, wherein the social network bank is configured to effectuate one or more social currency exchanges between at least one user of the plurality of users of the social network and a commercial banking institution.

One or more of the following features may be included. A request to exchange a defined quantity of the first social currency amount into a national/regional currency may be received from a first user having a first social currency amount. The defined quantity of the first social currency amount may be converted into a calculated quantity of the national/regional currency based, at least in part, upon an exchange rate. The calculated quantity of the national/regional currency may be transferred into an account within the commercial banking institution that is associated with the first user. The first social currency amount of the first user may be reduced by the defined quantity of the first social currency amount. A request to exchange a defined quantity of a national/regional currency into a social currency may be received from a first user having a first social currency amount. The defined quantity of the national/regional currency may be converted into a calculated social currency amount based, at least in part, upon an exchange rate. The defined quantity of the national/regional currency may be received from an account within the commercial banking institution that is associated with the first user. The first social currency amount of the first user may be increased by the calculated social currency amount.

In another implementation, a computer program product resides on a computer readable medium that has a plurality of instructions stored on it. When executed by a processor, the instructions cause the processor to perform operations including defining a plurality of users within a social network, wherein a social currency amount is associated with each of the plurality of users of the social network. A social network bank is established within the social network, wherein the social network bank is configured to effectuate one or more social currency exchanges between at least one user of the plurality of users of the social network and a commercial banking institution.

One or more of the following features may be included. A request to exchange a defined quantity of the first social currency amount into a national/regional currency may be received from a first user having a first social currency amount. The defined quantity of the first social currency amount may be converted into a calculated quantity of the national/regional currency based, at least in part, upon an exchange rate. The calculated quantity of the national/regional currency may be transferred into an account within the commercial banking institution that is associated with the first user. The first social currency amount of the first user may be reduced by the defined quantity of the first social currency amount. A request to exchange a defined quantity of a national/regional currency into a social currency may be received from a first user having a first social currency amount. The defined quantity of the national/regional currency may be converted into a calculated social currency amount based, at least in part, upon an exchange rate. The defined quantity of the national/regional currency may be received from an account within the commercial banking institution that is associated with the first user. The first social currency amount of the first user may be increased by the calculated social currency amount.

In another implementation, a computing system includes at least one processor and at least one memory architecture coupled with the at least one processor, wherein the computing system is configured to perform operations including defining a plurality of users within a social network, wherein a social currency amount is associated with each of the plurality of users of the social network. A social network bank is established within the social network, wherein the social network bank is configured to effectuate one or more social currency exchanges between at least one user of the plurality of users of the social network and a commercial banking institution.

One or more of the following features may be included. A request to exchange a defined quantity of the first social currency amount into a national/regional currency may be received from a first user having a first social currency amount. The defined quantity of the first social currency amount may be converted into a calculated quantity of the national/regional currency based, at least in part, upon an exchange rate. The calculated quantity of the national/regional currency may be transferred into an account within the commercial banking institution that is associated with the first user. The first social currency amount of the first user may be reduced by the defined quantity of the first social currency amount. A request to exchange a defined quantity of a national/regional currency into a social currency may be received from a first user having a first social currency amount. The defined quantity of the national/regional currency may be converted into a calculated social currency amount based, at least in part, upon an exchange rate. The defined quantity of the national/regional currency may be received from an account within the commercial banking institution that is associated with the first user. The first social currency amount of the first user may be increased by the calculated social currency amount.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a social networking process coupled to a distributed computing network;

FIG. 2 is a flow chart of one implementation of the social networking process of FIG. 1;

FIG. 3 is a diagrammatic view of various aspects of the social networking process of FIG. 1;

FIG. 4 is a flow chart of another implementation of the social networking process of FIG. 1; and

FIG. 5 is a flow chart of another implementation of the social networking process of FIG. 1.

Like reference symbols in the various drawings indicate like elements.

### DETAILED DESCRIPTION OF THE PREFERRED EMBODIMENTS

### System Overview:

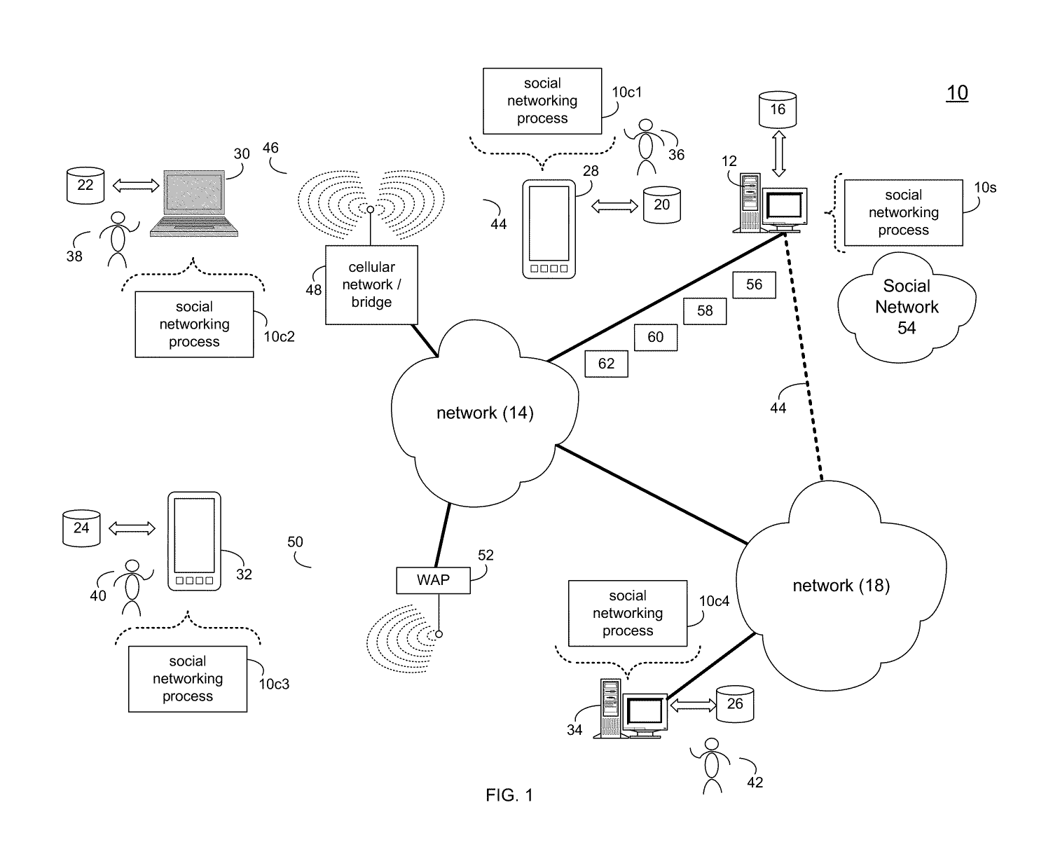

In FIG. 1, there is shown social networking process 10. As will be discussed below in greater detail, social networking process 10 may be configured to allow the various users of a social network to generate revenue and to transfer that revenue between various users of the social network.

Social networking process 10 may be implemented as a server-side process, a client-side process, or a hybrid server-side/client-side process. For example, social networking process 10 may be implemented as a purely server-side process via social networking process 10s. Alternatively, social networking process 10 may be implemented as a purely client-side process via one or more of social networking process 10c1, social networking process 10c2, social networking process 10c3, and social networking process 10c4. Alternatively still, social networking process 10 may be implemented as a hybrid server-side/client-side process via social networking process 10s in combination with one or more of social networking process 10c1, social networking process 10c2, social networking process 10c3, and social networking process 10c4. Accordingly, social networking process 10 as used in this disclosure may include any combination of social networking process 10s, social networking process 10c1, social networking process 10c2, social networking process 10c3, and social networking process 10c4.

Social networking process 10s may be a server application and may reside on and may be executed by computing device 12, which may be connected to network 14 (e.g., the Internet or a local area network). Examples of computing device 12 may include, but are not limited to: a personal computer, a laptop computer, a tablet computer, a personal digital assistant, a data-enabled cellular telephone, a notebook computer, a television with one or more processors embedded therein or coupled thereto, a server computer, a series of server computers, a mini computer, a mainframe computer, or a dedicated network device.

The instruction sets and subroutines of social networking process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a tape drive; an optical drive; a RAID device; a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of social networking processes 10c1, 10c2, 10c3, 10c4 may include but are not limited to a web browser, a game console user interface, a social network user interface, or a specialized application. The instruction sets and subroutines of social networking processes 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage devices 20, 22, 24, 26 may include but are not limited to: hard disk drives; tape drives; optical drives; RAID devices; random access memories (RAM); read-only memories (ROM), and all forms of flash memory storage devices.

Examples of client electronic devices 28, 30, 32, 34 may include, but are not limited to, data-enabled, cellular telephone 28, laptop computer 30, personal digital assistant 32, personal computer 34, a tablet computer (not shown), a notebook computer (not shown), a server computer (not shown), a smart television (not shown), a gaming console (not shown), and a dedicated network device (not shown). Client electronic devices 28, 30, 32, 34 may each execute an operating system.

Users 36, 38, 40, 42 may access social networking process 10 directly through network 14 or through secondary network 18. Further, social networking process 10 may be connected to network 14 through secondary network 18, as illustrated with link line 44.

The various client electronic devices (e.g., client electronic devices 28, 30, 32, 34) may be directly or indirectly coupled to network 14 (or network 18). For example, data-enabled, cellular telephone 28 and laptop computer 30 are shown wirelessly coupled to network 14 via wireless communication channels 44, 46 (respectively) established between data-enabled, cellular telephone 28, laptop computer 30 (respectively) and cellular network/bridge 48, which is shown directly coupled to network 14. Further, personal digital assistant 32 is shown wirelessly coupled to network 14 via wireless communication channel 50 established between personal digital assistant 32 and wireless access point (i.e., WAP) 52, which is shown directly coupled to network 14. Additionally, personal computer 34 is shown directly coupled to network 18 via a hardwired network connection.

WAP 52 may be, for example, an IEEE 802.11a, 802.11b, 802.11g, 802.11n, Wi-Fi, and/or Bluetooth device that is capable of establishing wireless communication channel 50 between personal digital assistant 32 and WAP 52. As is known in the art, IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Social Networking Process:

As discussed above, social networking process 10 may be configured to allow the various users of a social network (e.g., social network 54) to generate revenue and to transfer that revenue between various users of social network 54. Social networking process 10 may be included within and/or a portion of social network 54. Alternatively, social networking process 10 may be a standalone application/applet that is configured to interact with social network 54.

Social networking process 10 may be configured to allow users of social network 54 to engage in traditional social networking activities, such as defining a group of friends and/or followers and allowing users of social network 54 to generally document their lives by e.g., uploading photos and videos, providing updates concerning what they are currently doing, have done in the past, or will be doing in the future. Additionally, social networking process 10 may be configured to allow users of social network 54 to get opinions from their friends/followers by informally asking questions, such as “Where should I go on vacation next year?”, “I am looking to buy a reliable pickup truck . . . any suggestions?”, or “Looking for a great steakhouse in Chicago . . . thoughts?”.

However and as will be discussed below in greater detail, social networking process 10 may further be configured to promote (through financial motivation) polite social discourse and encourage the generation of quality original content by the users of social network 54.

Social Currency Scores & Amounts:

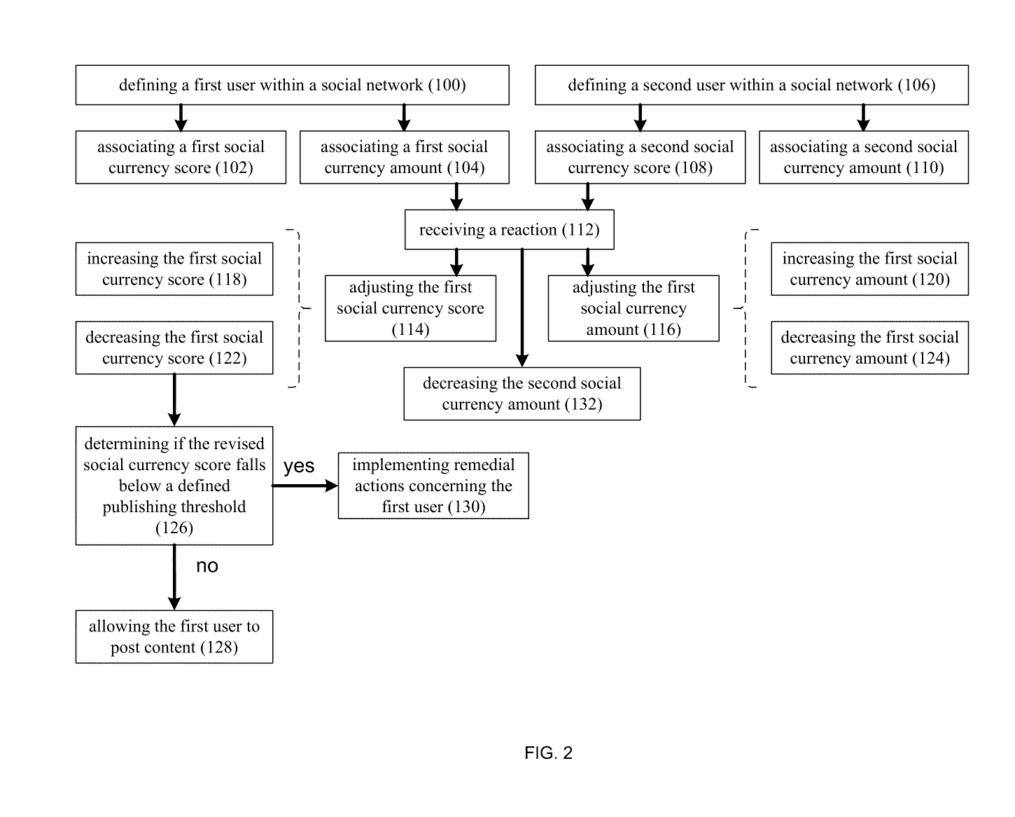

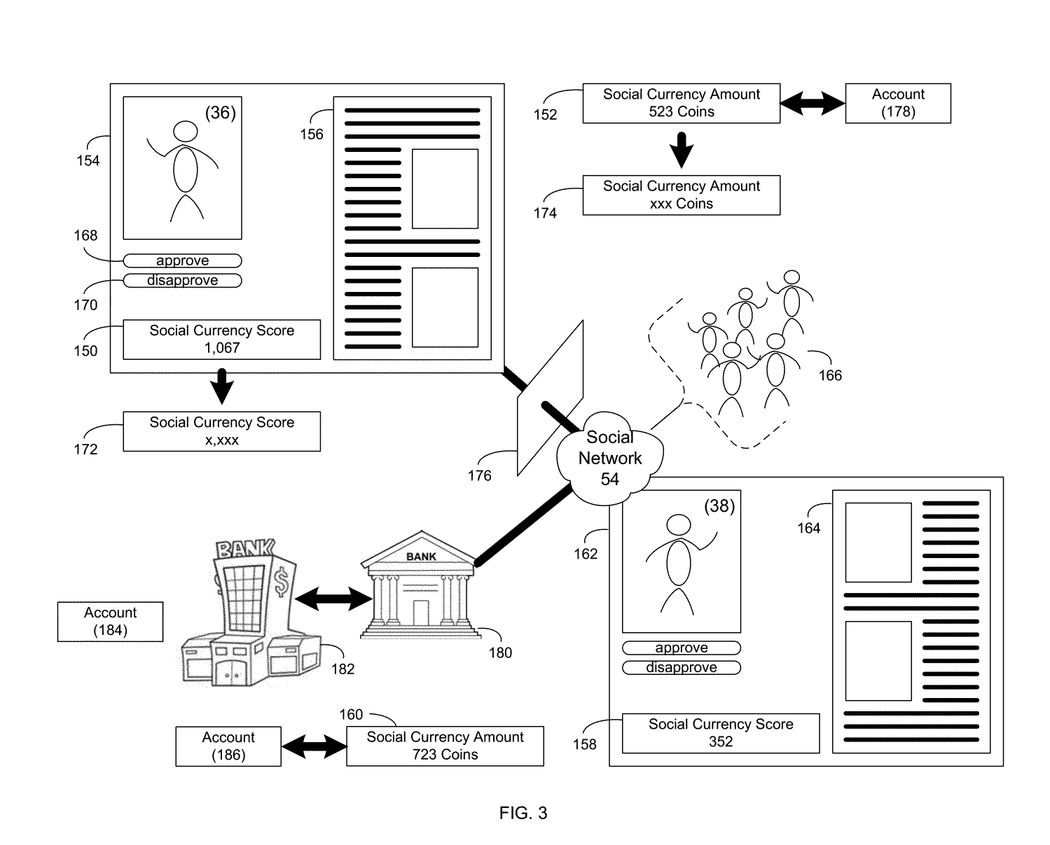

Referring also to FIGS. 2-3, social networking process 10 may define 100 a first user (e.g., user 36) within social network 54. When defining 100 user 36, social networking process 10 may associate 102 a first social currency score (e.g., first social currency score 150) and may also associate 104 a first social currency amount (e.g., first social currency amount 152) with the first user (e.g., user 36) of social network 54.

When user 36 is initially defined 100, social networking process 10 may initially associate 102 a first social currency score of “1” and initially associate 104 a first social currency amount of “1” for user 36. Once defined 100 as a user within social network 54, user 36 may create and maintain social webpage 154 (e.g., a “wall”) within which user 36 may upload photos and videos; provide updates concerning what they are currently doing, have done in the past, or will be doing in the future; and get opinions from their friends/followers (as discussed above and in the form of commentary/content 156).

Assume, for illustrative purposes only, that social networking process 10 also defines 106 a second user (e.g., user 38) within social network 54. Again and when defining 106 user 38, social networking process 10 may associate 108 a second social currency score (e.g., second social currency score 158) and may also associate 110 a second social currency amount (e.g., second social currency amount 160) with the second user (e.g., user 38) of social network 54.

As with user 36, when user 38 is initially defined 106, social networking process 10 may initially associate 108 a second social currency score of “1” and initially associate 110 a second social currency amount of “1” for user 38. Once defined 106 as a user within social network 54, user 38 may create and maintain social webpage 162 (e.g., a “wall”) within which user 38 may upload photos and videos; provide updates concerning what they are currently doing, have done in the past, or will be doing in the future; and get opinions from their friends/followers (as discussed above and in the form of commentary/content 164).

While the above discussion concerns social networking process 10 defining 100, 106 two users (namely user 36, 38) for social network 54, this is for illustrative purposes only and is not intended to be a limitation of this disclosure. For example, social networking process 10 may define plurality of users 166 for use within social network 54.

As discussed above, social networking process 10 may be configured to promote (through financial motivation) polite social discourse and encourage the generation of quality original content by the users of social network 54. As will be discussed below in greater detail, this goal may be accomplished through the use of the above-described social currency scores (e.g., social currency scores 150, 158) and social currency amounts (e.g., social currency amounts 152, 160). While the above-described social currency scores (e.g., social currency scores 150, 158) may be publically available, the above-described social currency amounts (e.g., social currency amounts 152, 160) may be hidden from public view and maintained in confidence.

Unlike many social networking websites that only allow users to “like” or “agree with” other users within the social network, social networking process 10 may be configured to allow users to declare that they do not like or agree with another user of social network 54. Accordingly, if one user of social network 54 is producing quality valuable content, a large quantity of users of social network 54 may publically approve of that user. Conversely, if another user of social network 54 continuously spews out hatred, a large quantity of users of social network 54 may publically disapprove of that user.

Assume for illustrative purposes that social networking process 10 receives 112 a reaction (e.g., reaction 56) concerning first user 36 of social network 54 from second user 38 of social network 54. For example, reaction 56 may be a reaction by e.g., user 38 to commentary/content 156 that user 36 posted on social webpage 154 (that is published within social network 54 and controlled by user 36). This reaction may be an approval reaction (i.e., a positive reaction to commentary/content 156) or a disapproval reaction (i.e., a negative reaction to commentary/content 156).

For example, “approve” button 168 may be included within social webpage 154 and may be configured to allow e.g., user 38 to provide the above-described positive reaction to commentary/content 156 (in the form of reaction 56). Additionally, “disapprove” button 170 may be included within social webpage 154 and may be configured to allow e.g., user 38 to provide the above-described negative reaction to commentary/content 156 (in the form of reaction 56). Accordingly and for this example, assume that user 38 visits social webpage 154 and selects one of “approve” button 168 or “disapprove” button 170, resulting in the generation of reaction 56 that is received 112 by social networking process 10.

Upon receiving 112 reaction 56, social networking process 10 may adjust 114 the first social currency score (e.g., first social currency score 150) of the first user (e.g., user 36) of social network 54 based, at least in part, upon reaction 56 from the second user (e.g., user 38) of social network 54, thus defining a revised social currency score (e.g., revised social currency score 172) for first user 36 of social network 54. Additionally and upon receiving 112 reaction 56, social networking process 10 may also adjust 116 the first social currency amount (e.g., first social currency amount 152) of the first user (e.g., user 36) of social network 54 based, at least in part, upon reaction 56 from the second user (e.g., user 38) of social network 54, thus defining a revised social currency amount (e.g., revised social currency amount 174) for first user 36 of social network 54.

Positive Reaction:

As discussed above, reaction 56 may be an approval reaction (i.e., a positive reaction) or a disapproval reaction (i.e., a negative reaction).

In the event that reaction 56 is an approval reaction (e.g., user 38 selected “approve” button 168), when adjusting 114 first social currency score 150, social networking process 10 may increase 118 first social currency score 150 of first user 36 of social network 54 based, at least in part, upon the approval reaction (e.g., reaction 56), thus defining revised social currency score 172 for first user 36 of social network 54. Further, when adjusting 116 first social currency amount 152, social networking process 10 may increase 120 first social currency amount 152 of first user 36 of social network 54 based, at least in part, upon approval reaction (e.g., reaction 56), thus defining revised social currency amount 174 for first user 36 of social network 54.

For example and in the event that reaction 56 is an approval reaction (e.g., user 38 selected “approve” button 168), social networking process 10 may increase 118 first social currency score 150 by a value of “1” (thus increasing 118 first social currency score 150 to a score of “1,068”. Further and in the event that reaction 56 is an approval reaction (e.g., user 38 selected “approve” button 168), social networking process 10 may increase 120 first social currency amount 152 by a value of “1” (thus increasing 120 first social currency amount 152 to a value of “524” coins.

Negative Reaction:

In the event that reaction 56 is a disapproval reaction (e.g., user 38 selected “disapprove” button 170), when adjusting 114 first social currency score 150, social networking process 10 may decrease 122 first social currency score 150 of first user 36 of social network 54 based, at least in part, upon the disapproval reaction (e.g., reaction 56), thus defining revised social currency score 172 for first user 36 of social network 54. Further, when adjusting 116 first social currency amount 152, social networking process 10 may decrease 124 first social currency amount 152 of first user 36 of social network 54 based, at least in part, upon the disapproval reaction (e.g., reaction 56), thus defining revised social currency amount 174 for first user 36 of social network 54.

For example and in the event that reaction 56 is a disapproval reaction (e.g., user 38 selected “disapprove” button 170), social networking process 10 may decrease 122 first social currency score 150 by a value of “1” (thus decreasing 122 first social currency score 150 to a score of “1,066”. Further and in the event that reaction 56 is a disapproval reaction (e.g., user 38 selected “disapprove” button 170), social networking process 10 may decrease 124 first social currency amount 152 by a value of “1” (thus decreasing 124 first social currency amount 152 to a value of “522” coins.

Accordingly, social networking process 10 may promote (through financial motivation) polite social discourse and encourage the generation of quality original content by the users of social network 54.

Social networking process 10 may determine 126 if the revised social currency score (e.g., revised social currency score 172) for first user 36 of social network 54 falls below a defined publishing threshold. For example, assume that such a predefined publishing threshold is “+1”.
If social networking process 10 determines 126 that the revised social currency score (e.g., revised social currency score 172) for first user 36 of social network 54 does not fall below the defined publishing threshold (e.g., “+1”), social networking process 10 may allow 128 first user 36 of social network 54 to post content (e.g., commentary/content 156) to social network 54.
If social networking process 10 determines 126 that the revised social currency score (e.g., revised social currency score 172) for first user 36 of social network 54 does fall below a defined publishing threshold (e.g., “+1”), social networking process 10 may implement 130 remedial actions concerning first user 36 of social network 54. Examples of such remedial actions may include but are not limited to: prohibiting first user 36 from posting content (e.g., commentary/content 156) to social network 54; prohibiting first user 36 from reacting to the content posted by other users of social network 54; prohibiting first user 36 from accepting endorsements; prohibiting first user 36 from accepting advertisements; prohibiting first user 36 from accepting content access requests; and prohibiting first user 36 from making currency transfers or exchanges.

As discussed above, a social currency amount (e.g., second social currency amount 160) may be associated with second user 38 of social network 54 (i.e., the user generating reaction 56). When generating such reactions (e.g., approval or disapproval reactions), social networking process 10 may charge the reacting user a fee for generating such a reaction (e.g., reaction 56). Accordingly, social networking process 10 may decrease 132 the social currency amount (e.g., second social currency amount 160) associated with second user 38 of social network 54 in response to receiving 112, from second user 38 of social network 54, reaction 56 concerning first user 36 of social network 54.

Accordingly and with such a system, social networking process 10 may regulate reactions by charging such a fee for doing so, thus increasing the likelihood that the users generating the reaction have a good faith basis of doing the same (as opposed to e.g., simply “liking” a viral video on a video media website).

Effectuating Transfers & Purchases:

Social networking process 10 may be configured to allow the various users (e.g., user 36, user 38 and/or any of plurality of users 166) of social network 54 to effectuate commercial transactions with each other.

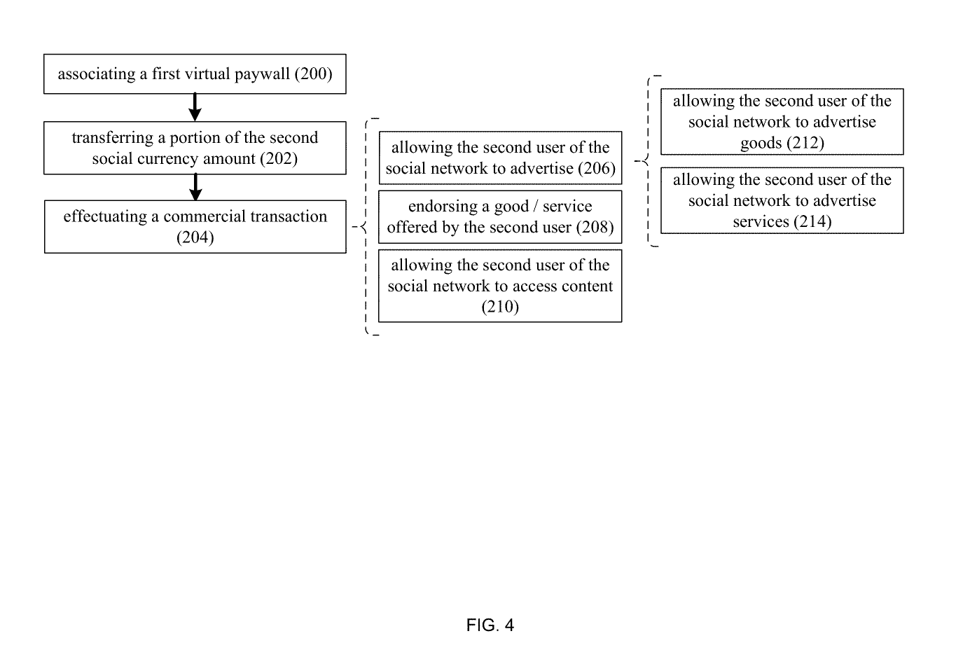

Referring also to FIG. 4, social networking process 10 may associate 200 a first virtual paywall (e.g., virtual paywall 176) with first user 36 of social network 54, wherein social networking process 10 may transfer 202, via the first virtual paywall (e.g., virtual paywall 176), a portion of (in this example) second social currency amount 160 to a first account (e.g., account 178) associated with first social currency amount 152, thus allowing (in this example) user 38 to transfer value (e.g., in the form of coins) from their social currency amount (e.g., second social currency amount 160) to the social currency amount of user 36 (namely first social currency amount 152).

In response to transferring 202 the portion of second social currency amount 160, social networking process 10 may effectuate 204 a commercial transaction between (in this example) user 36 of social network 54 and user 38 of social network 54.

When effectuating 204 the above-described commercial transaction, social networking process 10:
may allow 206 second user 38 of social network 54 to advertise on a portion (e.g., social webpage 154) of social network 54 controlled by first user 36 of social network 54;
may have user 36 endorse 208 a good/service offered by user 38 of social network 54; and/or
may allow 210 second user 38 of social network 54 to access content (e.g., commentary/content 156) produced by first user 36 of social network 54.

Assume for illustrative purposes that user 36 is a highly regarded race car driver that has a very good reputation in the industry (and, therefore, has a high social currency score). Accordingly, since user 36 has a high social currency score, user 36 is afforded with the above-described opportunities concerning advertisements, endorsements and content access; since the high social currency score of user 36 makes it desirable for a third party (e.g., user 38) to advertise on social webpage 154 of user 36, receive an endorsement from user 36, and/or read content produced by user 36. Further, assume that user 38 is automotive enthusiast that owns a performance tuning shop that specializes in modifying high-end, exotic sports cars. Accordingly, user 38 may transfer 202 (via virtual paywall 176) a portion of second social currency amount 160 to account 178 associated with first social currency amount 152 to:
allow 206 user 38 to advertise their high-end, exotic car modification services on social webpage 154 of social network 54;
have user 36 endorse 208 the high-end, exotic car modification services offered by user 38 of social network 54; and/or
allow 210 user 38 to access content (e.g., commentary/content 156) produced by user 36.

As discussed above, when generating reactions (e.g., approval or disapproval reactions), social networking process 10 may charge the reacting user a fee for generating such a reaction (e.g., reaction 56) and (in the event that the reaction is an approval reaction) may increase the social currency amount of the user receiving the approval reaction. Accordingly, virtual paywall 250 may be configured to handle such transactions. Therefore and in this example, the transfer of value (i.e., the portion of second social currency amount 160 via virtual paywall 176 may be initiated by a reaction (e.g., reaction 56) being received from second user 38 of social network 54 and concerning first user 36 of social network 54.

Naturally, for any of the above-described operations (namely allowing 206 advertisements, having endorsements 208 and/or allowing 210 access to content), social networking process 10 may be configured to allow the user receiving the transfer to refuse the arrangement. For example and in the above-described situation, user 36 may refuse to allow 206 user 38 to advertise, refuse to endorse 208 user 38 and/or refuse to allow 210 user 38 to access content (thus avoiding situations in which e.g., hate groups advertise on prominent social webpages).

Paid Advertisements:

As discussed above, social networking process 10 may be configured to allow the various users (e.g., user 36, user 38 and/or any of plurality of users 166) of social network 54 to effectuate commercial transactions with each other, wherein one example of such a commercial transaction may include allowing 206 second user 38 of social network 54 to advertise on a portion (e.g., social webpage 154) of social network 54 controlled by first user 36 of social network 54.

When allowing 206 second user 38 of social network 54 to advertise, social networking process 10 may:
allow 212 second user 38 of social network 54 to advertise goods offered for sale by second user 38 of social network 54; and/or
allow 214 second user 38 of social network 54 to advertise services offered for sale by second user 38 of social network 54.

As discussed above and as a precursor to effectuating 204 a commercial transaction between (in this example) user 36 and user 38, social networking process 10 may transfer 202 a portion of (in this example) second social currency amount 160 to a first account (e.g., account 178) associated with first social currency amount 152. The quantity of the transfer may vary depending upon various business and economic considerations.

For example, the portion of second social currency amount 160 transferred 202 may be based, at least in part, upon a first social currency score (e.g., first social currency score 150) associated with (in this example) first user 36 of social network 54. Accordingly, the higher first social currency score 150 is, the greater the portion of second social currency amount 160 transferred 202 to (in this example) first social currency amount 152, since an advertisement on a social webpage (e.g., social webpage 154) of a user with a high social currency score may be deemed more valuable.

Alternatively, the portion of second social currency amount 160 transferred 202 may be a flat fee defined by first user 36 or second user 38. For example, user 36 may only allow advertisement on social webpage 154 if (in this example) user 38 is willing to pay a (comparatively high) flat fee. Alternatively, user 38 may be constrained by corporate budgets and may only be able to purchase advertisements if (in this example) user 36 is willing to accept a (comparatively low) flat fee.

Further still, the portion of second social currency amount 160 transferred 202 may be an amount negotiated by first user 36 and second user 38. Accordingly and in such a situation, user 36 and user 38 may negotiate the portion of second social currency amount 160 transferred 202 specifically for this particular advertising campaign.

Social Network Bank:

As discussed above, social networking process 10 may define a plurality of users (e.g., user 36, user 38) within social network 54, wherein and as discussed above, a social currency amount (e.g., first social currency amount 152 and second social currency amount 160, respectively) may be associated with each of the plurality of users (e.g., user 36, user 38) of social network 54. Further and as discussed above, social networking process 10 may be configured to allow the various users (e.g., user 36, user 38) of social network 54 to transfer value to each other. For example, user 38 may transfer a portion of their social currency amount (e.g., second social currency amount 160) to the social currency amount of user 36 (namely first social currency amount 152).

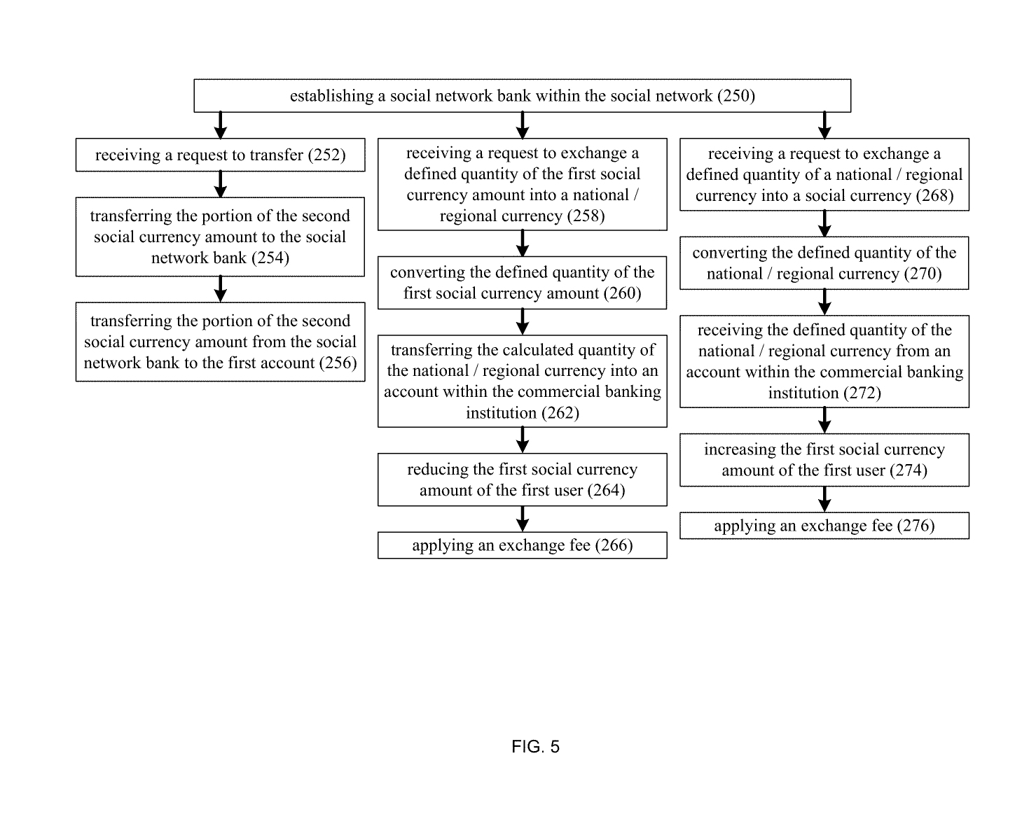

Referring also to FIG. 5, social networking process 10 may establish 250 social network bank 180 within social network 54, wherein social network bank 180 may be configured to effectuate one or more social currency transfers between the plurality of users (e.g., user 36, user 38) of social network 54.

Assume for illustrative purposes that user 38 wishes to transfer a portion (e.g., 500 coins) of their social currency amount (e.g., second social currency amount 160) to the social currency amount of user 36 (namely first social currency amount 152) to pay for user 36 agreeing to place an advertisement on the social webpage (e.g., social webpage 154) of user 36. Accordingly, user 38 may generate a request (e.g., request 58) to effectuate such a transfer. Therefore, request 58 may be based upon the effectuation of a commercial transaction (the placing of advertisements on social webpage 154).

Social networking process 10 may receive 252 request 58 to transfer a portion of second social currency amount 160 associated with second user 38 of social network 54 to a first account (e.g., account 178) associated with first social currency amount 152 that is associated with first user 36 of social network 54.

In response to receiving 252 request 58, social networking process 10 may transfer 254 the portion of second social currency amount 160 to social network bank 180. Social networking process 10 may then transfer 256 the portion of second social currency amount 160 from social network bank 180 to the first account (e.g., account 178) associated with first social currency amount 152 that is associated with first user 36. Accordingly, social network bank 180 may be configured to act as an intermediary during the transfer of value from (in this example) user 38 to user 36.

While the commercial transaction discussed above concerned first user 36 of social network 54 allowing second user 38 of social network 54 to advertise on a portion (e.g., social webpage 154) of social network 54 controlled by first user 36 of social network 54, this is for illustrative purposes only and is not intended to be a limitation of this disclosure. For example, request 58 may be based upon the effectuation of other commercial transactions, such as: first user 36 of social network 54 endorsing a good/service offered by second user 38 of social network 54; and/or first user 36 of social network 54 allowing second user 38 of social network 54 to access content (e.g., commentary/content 156) produced by first user 36 of social network 54.

In addition to being configured to effectuate one or more social currency transfers between the plurality of users of social network 54, social networking process 10 may further be configured to effectuate one or more social currency exchanges between at least one user of the plurality of users (e.g., user 36, user 38) of social network 54 and a commercial banking institution (e.g., commercial bank 182).

Assume for illustrative purposes that user 36 wishes to exchange a portion (e.g., 500 coins) of their social currency amount (e.g., first social currency amount 152) for a national/regional currency (e.g., US dollars). Accordingly, user 36 may generate a request (e.g., request 60) to effectuate such an exchange.

Social networking process 10 may receive 258, from first user 36 having first social currency amount 152, request 60 to exchange a defined quantity (e.g., 500 coins) of first social currency amount 152 into a national/regional currency (US dollars).

Social networking process 10 may convert 260 the defined quantity (e.g., 500 coins) of first social currency amount 152 into a calculated quantity of the national/regional currency based, at least in part, upon an exchange rate. For illustrative purposes, assume that the current exchange rate is “1 coin=5 US dollars”. Accordingly, the calculated quantity of the national/regional currency (i.e., US dollars) would be $2,500 US dollars.

Social networking process 10 may transfer 262 the calculated quantity of the national/regional currency (e.g., $2,500 US dollars) into an account (e.g., account 184) within the commercial banking institution (e.g., commercial bank 182) that is associated with first user 36. Social networking process 10 may also reduce 264 the first social currency amount (e.g., first social currency amount 152) of first user 36 by the defined quantity (e.g., 500 coins) of the first social currency amount (e.g., first social currency amount 152). Accordingly, social networking process 10 may reduce 264 first social currency amount 152 from “523 coins” to “23 coins”.

Social networking process 10 may charge the exchanging user (in this example, first user 36) with a commission fee for effectuating the above-described coin-to-currency exchange. By way of a non-limiting example, social networking process 10 may apply 266 an exchange fee that is equal to e.g., a flat fee, a fixed percentage, a fixed percentage that is not to exceed a defined coin/dollar amount, or a varying percentage that decreases as the amount of the exchange increases.

Social networking process 10 may allow for exchanges to occur in both directions. For example, assume for illustrative purposes that (several months later) user 36 wishes to exchange a defined quantity ($5,000) of a national/regional currency (US dollars) into a social currency for use within social network 54. Accordingly, user 36 may generate a request (e.g., request 62) to effectuate such an exchange.

Social networking process 10 may receive 268, from first user 36 having first social currency amount 152, request 62 to exchange a defined quantity (e.g., $5,000) of a national/regional currency (US dollars) into a social currency (e.g., coins for use with social network 54).

Social networking process 10 may convert 270 the defined quantity (e.g., $5,000) of the national/regional currency (US dollars) into a calculated social currency amount based, at least in part, upon an exchange rate. For illustrative purposes, assume that the current exchange rate is “5 US dollars=1 coin”. Accordingly, the calculated social currency amount would be 1,000 coins.

Social networking process 10 may receive 272 the defined quantity (e.g., $5,000) of the national/regional currency (US dollars) from an account (e.g., account 184) within the commercial banking institution (e.g., commercial bank 182) that is associated with first user 36. Social networking process 10 may also increase 274 the first social currency amount (e.g., first social currency amount 152) of first user 36 by the calculated social currency amount (e.g., 1,000 coins).

Social networking process 10 may charge the exchanging user (again and in this example, first user 36) with a commission fee for effectuating the above-described currency-to-coin exchange. By way of a non-limiting example, social networking process 10 may apply 276 an exchange fee that is equal to e.g., a flat fee, a fixed percentage, a fixed percentage that is not to exceed a defined coin/dollar amount, or a varying percentage that decreases as the amount of the exchange increases.

As discussed above, a social currency amount may be associated with each of the users of social network 54. For example, first social currency amount 152 may be associated with user 36 and second social currency amount 160 may be associated with user 38. First social currency amount 152 and second social currency amount 160 may be configured to perform the function of a wallet for users 36, 38 (respectively) for use within social network 54. Additionally and as discussed above, a first account (e.g., account 178) may be associated with first social currency amount 152. Further, a second account (e.g., account 186) may be associated with second social currency amount 160. Accounts 178, 186 may be configured to perform the function of a bank account for users 36, 38 (respectively) for use within social network 54. Social networking process 10 may be configured to: allow user 36 to transfer value between first social currency amount 152 and account 178; and allow user 38 to transfer value between second social currency amount 160 and account 186.

Further and as discussed above, in the event that reaction 56 is a disapproval reaction with respect to user 36 (e.g., user 38 selected “disapprove” button 170), social networking process 10 may decrease (in this example) first social currency amount 152 by a value of “1”. Accordingly, it may be in the best interest of users of social network 54 to transfer surplus value from e.g., first social currency amount 152 to account 178 and/or from e.g., second social currency amount 160 to account 186 (to avoid a loss of value of social currency amounts 152, 160).

### General:

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method executed on a computing device, the computer-implemented method comprising:
defining a plurality of users within a social network, wherein a social currency amount is associated with each of the plurality of users of the social network; and
establishing a social network bank within the social network, wherein the social network bank is configured to effectuate one or more social currency exchanges between at least one user of the plurality of users of the social network and a commercial banking institution.

2. The computer-implemented method of claim 1 further comprising:
receiving, from a first user having a first social currency amount, a request to exchange a defined quantity of the first social currency amount into a national/regional currency; and
converting the defined quantity of the first social currency amount into a calculated quantity of the national/regional currency based, at least in part, upon an exchange rate.

3. The computer-implemented method of claim 2 further comprising:
transferring the calculated quantity of the national/regional currency into an account within the commercial banking institution that is associated with the first user.

4. The computer-implemented method of claim 3 further comprising:
reducing the first social currency amount of the first user by the defined quantity of the first social currency amount.

5. The computer-implemented method of claim 1 further comprising:
receiving, from a first user having a first social currency amount, a request to exchange a defined quantity of a national/regional currency into a social currency; and
converting the defined quantity of the national/regional currency into a calculated social currency amount based, at least in part, upon an exchange rate.

6. The computer-implemented method of claim 5 further comprising:
receiving the defined quantity of the national/regional currency from an account within the commercial banking institution that is associated with the first user.

7. The computer-implemented method of claim 6 further comprising:
increasing the first social currency amount of the first user by the calculated social currency amount.

8. A computer program product residing on a computer readable medium having a plurality of instructions stored thereon which, when executed by a processor, cause the processor to perform operations comprising:
defining a plurality of users within a social network, wherein a social currency amount is associated with each of the plurality of users of the social network; and
establishing a social network bank within the social network, wherein the social network bank is configured to effectuate one or more social currency exchanges between at least one user of the plurality of users of the social network and a commercial banking institution.

9. The computer program product of claim 8 further comprising instructions for:
receiving, from a first user having a first social currency amount, a request to exchange a defined quantity of the first social currency amount into a national/regional currency; and
converting the defined quantity of the first social currency amount into a calculated quantity of the national/regional currency based, at least in part, upon an exchange rate.

10. The computer program product of claim 9 further comprising instructions for:
transferring the calculated quantity of the national/regional currency into an account within the commercial banking institution that is associated with the first user.

11. The computer program product of claim 10 further comprising instructions for:
reducing the first social currency amount of the first user by the defined quantity of the first social currency amount.

12. The computer program product of claim 8 further comprising instructions for:
receiving, from a first user having a first social currency amount, a request to exchange a defined quantity of a national/regional currency into a social currency; and
converting the defined quantity of the national/regional currency into a calculated social currency amount based, at least in part, upon an exchange rate.

13. The computer program product of claim 12 further comprising instructions for:
receiving the defined quantity of the national/regional currency from an account within the commercial banking institution that is associated with the first user.

14. The computer program product of claim 13 further comprising instructions for:
increasing the first social currency amount of the first user by the calculated social currency amount.

15. A computing system including a processor and memory configured to perform operations comprising:
defining a plurality of users within a social network, wherein a social currency amount is associated with each of the plurality of users of the social network; and
establishing a social network bank within the social network, wherein the social network bank is configured to effectuate one or more social currency exchanges between at least one user of the plurality of users of the social network and a commercial banking institution.

16. The computing system of claim 15 further configured to perform operations comprising:
receiving, from a first user having a first social currency amount, a request to exchange a defined quantity of the first social currency amount into a national/regional currency; and
converting the defined quantity of the first social currency amount into a calculated quantity of the national/regional currency based, at least in part, upon an exchange rate.

17. The computing system of claim 16 further configured to perform operations comprising:
transferring the calculated quantity of the national/regional currency into an account within the commercial banking institution that is associated with the first user.

18. The computing system of claim 17 further configured to perform operations comprising:
reducing the first social currency amount of the first user by the defined quantity of the first social currency amount.

19. The computing system of claim 15 further configured to perform operations comprising:
receiving, from a first user having a first social currency amount, a request to exchange a defined quantity of a national/regional currency into a social currency; and
converting the defined quantity of the national/regional currency into a calculated social currency amount based, at least in part, upon an exchange rate.

20. The computing system of claim 19 further configured to perform operations comprising:
receiving the defined quantity of the national/regional currency from an account within the commercial banking institution that is associated with the first user.

21. The computing system of claim 20 further configured to perform operations comprising:
increasing the first social currency amount of the first user by the calculated social currency amount.
